(19) United States
(12) Patent Application Publication
(10) Pub. No.: US 2022/0387257 A1
(43) Pub. Date: Dec. 8, 2022

(54) CONTAINER CLOSED WITH A PRESS-FIT CAP

(71) Applicants: Schott AG, Mainz (DE); SCHOTT SCHWEIZ AG, St. Gallen (CH)

(72) Inventors: Andreas Reisse, Regensburg (DE); Bertram Kimmerle, Widnau (CH); Alexander Humbertjean, Bad Krozingen (DE); Patrick Wolf, St. Gallen (CH)

(73) Assignees: Schott AG, Mainz (DE); SCHOTT SCHWEIZ AG, St. Gallen (CH)

(21) Appl. No.: 17/830,200

(22) Filed: Jun. 1, 2022

(30) Foreign Application Priority Data
Jun. 2, 2021 (EP) 21177452.6

(51) Int. Cl. A61J 1/14; A61J 1/06; A61J 1/20

(52) U.S. Cl. CPC A61J 1/1425; A61J 1/065; A61J 1/2048

(57) ABSTRACT

At least one closed container includes a glass container having a total height, being characterized by a center axis and including a shoulder region; and a press-fit cap closing the glass container and including a cylindrical body having an upper end and a lower end. P is any given point at the lower end of the press-fit cap that is located above the shoulder region and that lies on a straight line running parallel to the center axis and hitting an outer surface of the shoulder region at a point Q. Among these points P at the lower end of the press-fit cap point P′ is the one that has a smallest distance to its corresponding point Q′ and a distance between points P′ and Q′ on the straight line is in a range from 0.17 to 8.4 mm.

### CROSS REFERENCE TO RELATED APPLICATIONS

This application claims priority to European Patent Application No. 21177452.6 filed on Jun. 2, 2021, which is incorporated in its entirety herein by reference.

### BACKGROUND OF THE INVENTION

### 1. Field of the Invention

The present invention relates to a closed container including a glass container and a press-fit cap that closes the glass container. The invention also relates to the use of a press-fit cap to close a glass container and a process for preparing a closed container.

### 2. Description of the Related Art

In the pharmaceutical industry, containers are used for the primary packaging of drugs. Among the traditionally most used materials is a glass container, as it ensures stability, visibility, endurance, rigidity, moisture resistance, ease of capping, and economy. The glass containers for medicinal purposes currently on the market include glass vials made from glass tubing and blow-molded glass containers.

Medicaments such as vaccines are often stored in such glass vials prior to use. Vials typically include a body region that is typically cylindrical in shape and has a collar- and a neck region at the top of the vial. The neck- and collar region define a mouth for receiving the medicament into an interior chamber defined in the body region. Normally, the vials are filled with medicament, often followed by a lyophilization step, and then a pre-sterilized cap or closure device is installed to seal the medicament within the vial.

The vial cap is typically a four-piece assembly often referred to as a “press-fit cap” that includes a cap, a stopper, a cage that usually holds the stopper in the assembly and a body. The cage is located in the inside of the press-fit cap and comprises flexible engaging clips that, when the press-fit cap is pressed over the collar region of the glass container in order to introduce the stopper into the opening for a closure of the vial, engage so as to contact the outside of the vial at a defined position. Such a four-piece assembly is, for example, commercially available under the tradename RayDyLyo® (Raygroup SASU; France).

The above-described vial caps have to fulfill several requirements. On the one hand, they must ensure that the contents of the vials are hermetically sealed from the environment. Since the vials are usually closed with the vial caps in a fully automated process, for example within a lyophilization plant, it must be ensured that—irrespective of the production-related variations in the dimensions between the individual vials, particularly in the collar region, in the neck region, in the transition region between the collar region and the neck region and in the should region—the stoppers are always pressed completely into the opening of the vials. On the other hand, the vial caps must be firmly seated on the vials in such a way as to prevent unintentional removal of the vial caps and thus also unintentional manipulation of the contents of the vials.

What is needed in the art is a way to at least partly overcome a disadvantage arising from the prior art. What is also needed in the art is a way to provide an assembly of a glass container and a press-fit cap that, particularly when being used in an automated process in which a glass container is filled with a medicinal product and is subsequently closed by pressing the press-fit cap onto the top of the glass container, not only ensures a complete closure of all the glass containers used in such a process, but at the same time also leads to a closed container from which the press-fit cap cannot simply be removed by mechanical forces.

### SUMMARY OF THE INVENTION

In some exemplary embodiments provided according to the present invention, at least one closed container includes a glass container and a press-fit cap closing the glass container. The glass container has a total height (h1) and is characterized by a center axis. The glass container including in a direction from a top to a bottom: a top region that includes an opening; a collar region including a collar with a collar height (h21) following the top region, an outer diameter of the glass container in the collar region is d2; a transition region that connects the collar region with a neck region including a neck, an outer diameter of the glass container in the neck region is d3 and an inner diameter of the glass container in the neck region is d4; a shoulder region including a shoulder; a body region including a body that follows the shoulder region, the glass container in the body region has an outer diameter d1; a heel region including a heel that follows the body region; and a bottom region including the bottom that follows the heel region and that closes the glass container at the bottom. An outer contour of the top region includes in the following order: a first outer surface inclined downwards towards the collar region, a convex curved, circular arc-shaped area adjacent to the first outer surface; a second outer surface adjacent to the convex curved, circular arc-shaped area and being substantially parallel to the center axis; an outer contour of the transition region that connects the collar region with the neck region includes in the following order: a convex curved, circular arc-shaped area having a lower collar radius (r24); and a concave curved, circular arc-shaped area having a collar and neck radius (r22). The outer contour of the transition region further includes a turning point located between the convex curved, circular arc-shaped area and the concave curved, circular arc-shaped area and a tangent line applied at this turning point encloses a lower collar angle (c21) with an axis perpendicular to the center axis. The press-fit cap includes a cylindrical body having an upper end and a lower end and at least two engaging clips that are arranged at an inside of the cylindrical body. The at least two engaging clips are adapted and arranged in such a manner that, when the press-fit cap is pressed over the collar region of the glass container in order to close the glass container, the engaging clips engage so as to contact an outside of the glass container in the transition region between the collar region and the neck region. P is any given point at a lower end of the press-fit cap that is located above the shoulder region and that lies on a straight line running parallel to the center axis and hitting an outer surface of the shoulder region at a point Q. Among these points P at the lower end of the press-fit cap a point P′ is the one that has the smallest distance to its corresponding point Q′. A distance between points P′ and Q′ on the straight line is in a range from 0.17 to 8.4 mm.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a closed container provided according to the present invention;

FIG. 2 is a cross-sectional view of a top region and a collar region of a glass container forming a part of the closed container provided according to the present invention;

FIG. 3 illustrates how the distance between a given point at a lower end of a press-fit cap and a corresponding point that is located above a shoulder region is determined and how points P′ and Q′ are selected;

FIG. 4A illustrates a side view of the container provided according the present invention and how to determine a neck height of the container;

FIG. 4B illustrates a side view of the container provided according to the present invention and how to determine a collar heigh and a lower collar angle of the container;

FIG. 5 illustrates how to determine the collar and neck radius;

FIG. 6 illustrates how to determine the lower collar radius;

FIG. 7 is a cross-sectional view of the collar region, the neck region, and the shoulder region of a glass container forming a part of the closed container provided according to the present invention, with geometric parameters r22, h21 and c21 being illustrated;

FIG. 8 shows a glass container that is a part of the closed container provided according to the present invention in a cross-sectional view;

FIG. 9 shows a glass container that is a part of the closed container provided according to the present invention in a cross-sectional view;

FIG. 10 shows a press-fit cap that is a part of the closed container provided according to the present invention in a cross-sectional view;

FIGS. 11A and 11B show two different closed containers provided according to the present invention in a cross-sectional view; and

FIG. 12 shows a closed container provided according to the present invention that, in addition to the glass container and the press-fit cap, further includes a rubber stopper.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

In some exemplary embodiments provided according to the invention, a closed container includes:

A) a glass container, for example a glass container in the form of a vial, and
B) a press-fit cap which closes the glass container;
A) the glass container has a total height h1 and is characterized by a center axis and the glass container includes in a direction from the top (102) to the bottom:
   I) a top region that includes an opening;
   II) a collar region including a collar with a collar height h21 following the top region, wherein the outer diameter of the glass container in the collar region is d2;
   III) a transition region that connects the collar region with a neck region;
   IV) the neck region including a neck, wherein the outer diameter of the glass container in the neck region is d3 and wherein the inner diameter of the glass container in the neck region is d4;
   V) a shoulder region including a shoulder;
   VI) a body region including a body that follows the shoulder region, wherein the glass container in the body region has an outer diameter d1;
   VII) a heel region including a heel that follows the body region;
   and
   VIII) a bottom region including a bottom that follows the heel region and that closes the glass container at the bottom;
      wherein the outer contour of the top region includes in the following order:
      IA) a first outer surface inclined downwards towards the collar region,
      IB) a convex curved, circular arc-shaped area adjacent to the first outer surface;
      IC) a second outer surface adjacent to the convex curved, circular arc-shaped area and being substantially parallel to the center axis;
      wherein the outer contour of the transition region that connects the collar region with the neck region includes in the following order:
      IIIA) a convex curved, circular arc-shaped area having a lower collar radius r24;
      IIIB) a concave curved, circular arc-shaped area having a collar and neck radius r22;
      wherein the outer contour of the transition region further includes a turning point located between the convex curved, circular arc-shaped area and the concave curved, circular arc-shaped area and wherein a tangent line applied at this turning point encloses a lower collar angle c21 with an axis perpendicular to the center axis;
B) the press-fit cap includes a cylindrical body having an upper end and a lower end and at least two engaging clips that are arranged at the inside of the cylindrical body, each engaging clip may include retaining portions inclined upwardly, wherein the clips are adapted and arranged in such a manner that, when the press-fit cap is pressed over the collar region of the glass container in order to close the glass container, the engaging clips, for example by the retaining portions, engage so as to contact the outside of the glass container in the transition region between the collar region and the neck region, wherein P is any given point at the lower end of the press-fit cap that is located above the shoulder region and that lies on a straight line running parallel to the center axis and hitting the outer surface of the shoulder region at a point Q, wherein among these points P at the lower end of the press-fit cap point P′ is the one that has the smallest distance to its corresponding point Q′, wherein the distance between points P′ and Q′ on the straight line is in a range from 0.17 to 8.4 mm, for example in a range from 0.2 to 8 mm, in a range from 0.3 to 7.5 mm, 0.4 to 7 mm, 0.5 to 6 mm, 0.6 to 5 mm, 0.7 to 4 mm, 0.8 to 3 mm, 0.9 to 2 mm, or 1 to 1.5 mm.

Some exemplary embodiments provided according to the invention provide a plurality of closed containers, each closed container including

A) a glass container, for example a glass container in the form of a vial, and
B) a press-fit cap which closes the glass container;
wherein
A) the glass container has a total height h1 and is characterized by a center axis, wherein the glass container includes in a direction from the top to the bottom:
   I) a top region that includes an opening;
   II) a collar region including a collar with a collar height h21 following the top region, wherein the outer diameter of the glass container in the collar region is d2;
   III) a transition region that connects the collar region with a neck region;
   IV) the neck region including a neck, wherein the outer diameter of the glass container in the neck region is d3 and wherein the inner diameter of the glass container in the neck region is d4;
   V) a shoulder region including a shoulder;
   VI) a body region including a body that follows the shoulder region, wherein the glass container in the body region has an outer diameter d1;
   VII) a heel region including a heel that follows the body region;
   and
   VIII) a bottom region including a bottom that follows the heel region and that closes the glass container at the bottom;
      wherein the outer contour of the top region includes in the following order:
      IA) a first outer surface inclined downwards towards the collar region,
      IB) a convex curved, circular arc-shaped area adjacent to the first outer surface;
      IC) a second outer surface adjacent to the convex curved, circular arc-shaped area and being substantially parallel to the center axis;
      wherein the outer contour of the transition region that connects the collar region with the neck region includes in the following order:
      IIIA) a convex curved, circular arc-shaped area having a lower collar radius r24;
      IIIB) a concave curved, circular arc-shaped area having a collar and neck radius r22;
      wherein the outer contour of the transition region further includes a turning point located between the convex curved, circular arc-shaped area and the concave curved, circular arc-shaped area and wherein a tangent line applied at this turning point encloses a lower collar angle c21 with an axis perpendicular to the center axis;
B) the press-fit cap includes a cylindrical body having an upper end and a lower end and at least two engaging clips that are arranged at the inside of the cylindrical body, each engaging clip may include retaining portions inclined upwardly, wherein the engaging clips are adapted and arranged in such a manner that, when the press-fit cap is pressed over the collar region of the glass container in order to close the glass container, the engaging clips, for example by the retaining portions, engage so as to contact the outside of the glass container in the transition region between the collar region and the neck region,
   wherein P is any given point at the lower end of the press-fit cap that is located above the shoulder region and that lies on a straight line running parallel to the center axis and hitting the outer surface of the shoulder region at a point Q, wherein among these points P at the lower end of the press-fit cap point P′ is the one that has the smallest distance to its corresponding point Q′,
   wherein for at least 90%, for example for at least 95%, for at least 97% or for at least 99% of the closed containers in the plurality of closed containers the distance between points P′ and Q′ on the straight line is in a range from 0.17 to 8.4 mm, for example in a range from 0.2 to 8 mm, in a range from 0.3 to 7.5 mm, 0.4 to 7 mm, 0.5 to 6 mm, 0.6 to 5 mm, 0.7 to 4 mm, 0.8 to 3 mm, 0.9 to 2 mm, or 1 to 1.5 mm.

“A plurality of closed containers” in the sense of the present invention may include at least 10 closed containers, for example at least 25 closed containers, at least 50 closed containers, at least 100 closed containers, at least 200 closed containers or at least 400 closed containers. Furthermore, the plurality of closed containers may be collected arbitrarily and particularly has not been selected with regard to any property. For example, the plurality closed containers may be the group of closed containers which are packed together in a typical transport tray.

Surprisingly, it has been discovered that by controlling the distance between the shoulder region of a glass container to the lowest point of a press-fit cap which closes the glass container to be within the very narrow range of 0.17 to 8.4 mm not only ensures a complete closure of the glass container, but at the same time also leads to a closed container from which the press-fit cap cannot simply be removed by mechanical forces, especially a mechanical lever.

In view of the rotation symmetry of both the glass container and the press-fit cap, the distance between points P′ and Q′ is usually the same along a circle located above the shoulder region, wherein the center axis runs through the center point of the circle and wherein the circle is lying in a plane that is perpendicular to the center axis, provided that the press-fit cap is placed straight on the glass container.

In some embodiments of the closed container and of the plurality of closed containers provided according to the present invention, d2 in the closed container or in at least 75%, for example in at least 85%, in at least 95% or in each closed container contained in the plurality of closed containers is in a range from 11.7 to 13.2 mm or in a range from 17.8 to 20.2 mm, for example in a range from 11.9 to 12.7 mm or in a range from 18.0 to 19.7 mm or in a range from 12.1 to 12.6 mm or in a range from 18.2 to 19.6 mm.

In some embodiments of the closed container and of the plurality of closed containers provided according to the present invention, d3 in the closed container or in at least 75%, for example in at least 85%, in at least 95% or in each closed container contained in the plurality of closed containers is in a range from 9.5 to 10.7 mm, in a range from 14.0 to 16.5 mm or in a range from 15.0 to 17.5 mm, for example in a range from 9.6 to 10.4 mm, in a range from 14.1 to 16.4 mm or in a range from 15.1 to 17.4 mm or in a range from 9.7 to 10.3 mm, in a range from 14.2 to 16.3 mm or in a range from 15.2 to 17.3 mm.

In some embodiments of the closed container and of the plurality of closed containers provided according to the present invention, d4 in the closed container or in at least 75%, for example in at least 85%, in at least 95% or in each closed container contained in the plurality of closed containers is in a range from 5.0 to 7.2 mm or in a range from 10.4 to 12.8 mm, for example in a range from 5.1 to 6.8 mm or in a range from 10.5 to 12.4 mm or in a range from 5.2 to 6.7 mm or in a range from 10.6 to 12.3 mm.

In some embodiments of the closed container and of the plurality of closed containers provided according to the present invention, r22 in the closed container or in at least 75%, for example in at least 85%, in at least 95% or in each closed container contained in the plurality of closed containers is in a range from 0.3 to 1.0 mm, for example in a range from 0.5 to 0.9 mm or in a range from 0.7 to 0.8 mm.

In some embodiments of the closed container and of the plurality of closed containers provided according to the present invention, r24 in the closed container or in at least 75%, for example in at least 85%, in at least 95% or in each closed container contained in the plurality of closed containers is 0.5 mm or less, for example 0.4 mm or less or 0.3 mm or less.

In some embodiments of the closed container and of the plurality of closed containers provided according to the present invention, c21 in the closed container or in at least 75%, for example in at least 85% in at least 95% or in each closed container contained in the plurality of closed containers is in a range from 3 to 20°, for example in a range from 5 to 15° or in a range from 7 to 10°.

In some embodiments of the closed container and of the plurality of closed containers provided according to the present invention, the outer contour of the top region further includes a third outer surface adjacent to the first outer surface, wherein the third outer surface is inclined downwards into the inside of the glass container and which encloses an angle c24 with the center axis, wherein c24 in the closed container or in at least 75%, for example in at least 85%, in at least 95% or in each closed container contained in the plurality of closed containers is in a range from 30 to 50°, for example in a range from 33 to 47° or in a range from 37 to 43°.

In some embodiments of the closed container and of the plurality of closed containers provided according to the present invention, the neck height h21 in the closed container or in at least 75%, for example in at least 85%, in at least 95% or in each closed container contained in the plurality of closed containers is in a range from 1.3 to 3.6 mm, for example in a range from 1.5 to 3.4 mm or in a range from 1.7 to 3.3 mm.

In some embodiments of the closed container and of the plurality of closed containers provided according to the present invention, the press-fit cap includes
i) a cylindrical body having an inner diameter d6, for example made of a polymer such as polybutylene terephthalate;
ii) a cage located inside of the cylindrical body, for example made of a polymer such as polycarbonate, wherein the cap cage includes at least two engaging clips, each clip for example including retaining portions inclined upwardly;
iii) a removable cap located on top of the cylindrical body, for example made of a polymer such as polypropylene;
   wherein the body and the cage at the top of the press-fit cap include and opening which is accessible if the cap is removed.

In this context it may be provided that d6 is at least 0.9×d1, for example at least 0.95×d1 or at least 1.0×d1. In such embodiments of a closed container provided according to the present invention it may be the lowest portion of the cage that is closest to the shoulder region.

In some embodiments of the closed container and of the plurality of closed containers provided according to the present invention, the press-fit cap has a maximum outer diameter d_{cap} in the range from 13.3 to 14.5 mm or in the range from 20.1 to 21.5 mm, for example in the range from 13.4 to 14.4 mm or in the range from 20.2 to 21.4 mm, in the range from 13.5 to 14.3 mm or in the range from 20.3 to 21.3 mm, in the range from 13.6 to 14.2 mm or in the range from 20.4 to 21.2 mm, and in the range from 13.7 to 14.1 mm or in the range from 20.5 to 21.1 mm.

In some embodiments of the closed container and of the plurality of closed containers provided according to the present invention, the press-fit cap has a height heap in the range from 4.5 to 7.5 mm, for example in the range from 4.8 to 7.2 mm, in the range from 5 to 7 mm, in the range from 5.2 to 6.8 mm or in the range from 5.5 to 6.5 mm.

In some embodiments of the closed container and of the plurality of closed containers provided according to the present invention, the closed glass container or each closed container contained in the plurality of closed containers further includes

C) a rubber stopper,
wherein the rubber stopper includes a first portion that rests on the top region and a second portion that is inserted into the opening of the top region. If such a rubber stopper is used in combination with a press-fit cap, the first cylindrical portion of the rubber stopper is at least in part accessible if the cap is removed. Liquids can thus be removed from the glass container by, for example, inserting the needle of a syringe centrally through the rubber stopper into the glass container.

In some embodiments, the first portion of the rubber stopper has that shape of a disc-shaped flange having a diameter that approximately has the size d2 (i. e. the size of the outer diameter of the glass container in the collar region). Attached to the lower side of the first portion of the rubber stopper is the second portion that may shaped in the form of tubular legs that may be formed to be continuous to a lower surface side of the flange portion. Also, notches may be provided at two locations in a circumferential direction of such a leg portion. The outer diameter of the second portion may be slightly larger than the inner diameter d4 of the glass container in the neck region in order to ensure that the glass container is sufficiently sealed when the second portion of the rubber stopper is introduced into the opening of the top region. Examples of suitable rubber stoppers are, for example, disclosed in US 2016/0075485A1.

In some embodiments of the closed container and of the plurality of closed containers provided according to the present invention, in which the closed glass container or each closed container contained in the plurality of closed containers further includes a rubber stopper, the closed glass container or each closed container contained in the plurality of closed containers may additionally include

D) a crimped top seal,
by which the rubber stopper is at least partially superimposed on the top side of the first cylindrical portion, wherein the crimped to seal surrounds the collar region of the glass container. In some embodiments, the crimped top seal is prepared by crimping a metallic (for example aluminum) or a polymeric (for example polypropylene) skirt under the transition region between the collar region and the neck region of the glass container. The press-fit-cap is subsequently pressed over the crimped top seal that surrounds the collar region of the glass container.

In some embodiments of the closed container and of the plurality of closed containers provided according to the present invention, the closed glass container or each closed container contained in the plurality of closed containers further includes

E) a vial adaptor.

In some embodiments, the vial adaptor has an inner diameter and a height with such dimensions that the vial adaptor can be placed on the press-fit cap.

In some embodiments of the closed container and of the plurality of closed containers provided according to the present invention, the closed glass container or each closed container contained in the plurality of closed containers further includes

F) a liquid or solid composition, for example a liquid or solid composition including a pharmaceutical active ingredient, such as a pharmaceutical composition.

In some exemplary embodiments provided according to the present invention, a use of a press-fit cap B is provided. The press-fit cap includes
B) a cylindrical body having an upper end and a lower end and at least two engaging clips that are arranged at the inside of the cylindrical body, each engaging clip for example including retaining portions inclined upwardly, wherein the engaging clips are adapted and arranged in such a manner that, when the press-fit cap is pressed over the collar region of a glass container in order to close the glass container, the engaging clips, for example by the retaining portions, engage so as to contact the outside of the glass container in the transition region between the collar region and the neck region;
   to close a glass container A) wherein
A) the glass container has a total height h1 and is characterized by a center axis, wherein the glass container includes in a direction from the top (102) to the bottom:
   I) a top region that includes an opening;
   II) a collar region including a collar with a collar height h21 following the top region, wherein the outer diameter of the glass container in the collar region is d2;
   III) a transition region that connects the collar region with a neck region;
   IV) the neck region including a neck, wherein the outer diameter of the glass container in the neck region is d3 and wherein the inner diameter of the glass container in the neck region is d4;
   V) a shoulder region including a shoulder;
   VI) a body region including a body that follows the shoulder region, wherein the glass container in the body region has an outer diameter d1;
   VII) a heel region including a heel that follows the body region;
   and
   VIII) a bottom region including a bottom that follows the heel region and that closes the glass container at the bottom;
      wherein the outer contour of the top region includes in the following order:
      IA) a first outer surface inclined downwards towards the collar region,
      IB) a convex curved, circular arc-shaped area adjacent to the first outer surface;
      IC) a second outer surface adjacent to the convex curved, circular arc-shaped area and being substantially parallel to the center axis;
      wherein the outer contour of the transition region that connects the collar region with the neck region includes in the following order:
      IIIA) a convex curved, circular arc-shaped area having a lower collar radius r24;
      IIIB) a concave curved, circular arc-shaped area having a collar and neck radius r22;
      wherein the outer contour of the transition region further includes a turning point located between the convex curved, circular arc-shaped area and the concave curved, circular arc-shaped area and wherein a tangent line applied at this turning point encloses a lower collar angle c21 with an axis perpendicular to the center axis;
         wherein, when the press-fit cap is pressed over the collar region of the glass container in order to close the glass container and when the engaging clips, for example by the retaining portions, engage so as to contact the outside of the glass container in the transition region between the collar region and the neck region, P is any given point at the lower end of the press-fit cap that is located above the shoulder region and that lies on a straight line running parallel to the center axis and hitting the outer surface of the shoulder region at a point Q, wherein among these points P at the lower end of the press-fit cap point P′ is the one that has the smallest distance to its corresponding point Q′, wherein the distance between points P′ and Q′ on the straight line is in a range from 0.17 to 8.4 mm, for example in a range from 0.2 to 8 mm, in a range from 0.3 to 7.5 mm, 0.4 to 7 mm, 0.5 to 6 mm, 0.6 to 5 mm, 0.7 to 4 mm, 0.8 to 3 mm, 0.9 to 2 mm, or 1 to 1.5 mm. In this context it may be provided that the press-fit cap is designed according to a previously described embodiment of the closed container provided according to the present invention and that the glass container is designed according to a previously described embodiment.

In some embodiments of the use provided according to the present invention, the glass container to be closed by the press-fit cap is already closed by a rubber stopper, wherein the rubber stopper includes a first cylindrical portion that rests on the top region and a second cylindrical portion that is inserted into the opening of the top region. When closing such a glass container, the press-fit cap is pressed over the collar region of the glass container until the inner surface of the top region of the press-fit cap rests on the upper surface of the first cylindrical portion of the rubber stopper.

In some embodiments of the use provided according to the present invention, the glass container further includes a crimped top seal by which the rubber stopper is at least partially superimposed on the top side of the first cylindrical portion, wherein the crimped to seal surrounds the collar region of the glass container. In some embodiments, the crimped top seal is prepared by crimping a metallic (usually aluminum) skirt under the transition region between the collar region and the neck region of the glass container. The press-fit-cap is subsequently pressed over the crimped top seal that surrounds the collar region of the glass container.

In some embodiments of the use provided according to the present invention, the glass container to be closed by the press-fit cap is not already closed by a rubber stopper. In this case, a rubber stopper that includes a first cylindrical portion and a second cylindrical portion is accommodated in the interior of the press-fit cap in such a manner that, when the press-fit cap is pressed over the collar region of the glass container, the first cylindrical portion of the rubber stopper is introduced into the opening and the second cylindrical portion of the rubber stopper rests on the top region.

In some embodiments of the use provided according to the present invention, the glass container to be closed by the press-fit cap includes a pharmaceutical composition.

In some exemplary embodiments provided according to the present invention, a process for preparing a closed container includes the steps:
i) providing a glass container A) as defined in context with the use provided according to the present invention;
ii) closing the glass container A) with a press-fit cap B) as defined in context with the use provided according to the present invention by pressing the press-fit cap over the collar region of the glass container;
   wherein, when the press-fit cap is pressed over the collar region of the glass container and when the engaging clips, for example by the retaining portions, engage so as to contact the outside of the glass container in the transition region between the collar region and the neck region, P is any given point at the lower end of the press-fit cap that is located above the shoulder region and that lies on a straight line running parallel to the center axis and hitting the outer surface of the shoulder region at a point Q, wherein among these points P at the lower end of the press-fit cap point P′ is the one that has the smallest distance to its corresponding point Q′, wherein the distance between points P′ and Q′ on the straight line is in a range from 0.17 to 8.4 mm, for example in a range from 0.2 to 8 mm, in a range from 0.3 to 7.5 mm, 0.4 to 7 mm, 0.5 to 6 mm, 0.6 to 5 mm, 0.7 to 4 mm, 0.8 to 3 mm, 0.9 to 2 mm, or 1 to 1.5 mm.

In some embodiments of the process provided according to the present invention, the glass container to be closed by the press-fit cap in process step ii) is already closed by a rubber stopper, wherein the rubber stopper includes a first cylindrical portion that rests on the top region and a second cylindrical portion that is inserted into the opening of the top region.

In some embodiments of the process provided according to the present invention, the glass container to be closed by the press-fit cap in process step ii) is not already closed by a rubber stopper, but is closed by a press-fit cap that accommodates the rubber stopper in the interior of the press-fit cap.

Glass

The glass of the glass container can be any type of glass and may consist of any material or combination of materials which the skilled person deems suitable in the context of the invention. In some embodiments, the glass is suitable for pharmaceutical packaging. In some embodiments, the glass is of type I, for example type I b, in accordance with the definitions of glass types in section 3.2.1 of the European Pharmacopoeia, 7^{th} edition from 2011. Additionally, or alternatively to the preceding, the glass is selected from the group consisting of a borosilicate glass, an aluminosilicate glass, soda lime glass and fused silica; or a combination of at least two thereof. For the use in this document, an aluminosilicate glass is a glass which has a content of Al₂O₃ of more than 8 wt.-%, for example more than 9 wt.-% or in a range from 9 to 20 wt.-%, in each case based on the total weight of the glass. An exemplary aluminosilicate glass has a content of B₂O₃ of less than 8 wt.-%, for example at maximum 7 wt.-%, or in a range from 0 to 7 wt.-%, in each case based on the total weight of the glass. For the use in this document, a borosilicate glass is a glass which has a content of B₂O₃ of at least 1 wt.-%, for example at least 2 wt.-%, at least 3 wt.-%, at least 4 wt.-%, at least 5 wt.-%, or in a range from 5 to 15 wt.-%, in each case based on the total weight of the glass. An exemplary borosilicate glass has a content of Al₂O₃ of less than 7.5 wt.-%, for example less than 6.5 wt.-% or in a range from 0 to 5.5 wt.-%, in each case based on the total weight of the glass. In some embodiments, the borosilicate glass has a content of Al₂O₃ in a range from 3 to 7.5 wt.-%, for example in a range from 4 to 6 wt.-%, in each case based on the total weight of the glass.

A glass which is further provided according to the invention is essentially free from B. Therein, the wording “essentially free from B” refers to glasses which are free from B which has been added to the glass composition by purpose. This means that B may still be present as an impurity, but for example at a proportion of not more than 0.1 wt.-%, or not more than 0.05 wt.-%, in each case based on the weight of the glass.

### Pharmaceutical Composition

In the context of the invention, every liquid pharmaceutical composition which the skilled person deems suitable to be used in a glass container, particularly in a vial that is closed with a press-fit cap, comes into consideration. A pharmaceutical composition is a composition including at least one active ingredient. An exemplary active ingredient is a vaccine. A further exemplary pharmaceutical composition is a parenterialium, i. e. a composition which is intended to be administered via the parenteral route, which may be any route which is not enteral. Parenteral administration can be performed by injection, e.g. using a needle (usually a hypodermic needle) and a syringe.

In some embodiments of the closed container or of the plurality of closed containers provided according to the present invention, the closed container or each closed container in the plurality of closed containers is a vial with an overflow capacity equal to or larger than 1 ml up to maximal 5 ml, for example a vial with a size designation “2R” according to DIN EN ISO 8362-1:2016-06, wherein it is furthermore provided that at least one, for example all, of the following conditions i) to vi) may be fulfilled:
i) h1 is in a range from 34.5 to 35.5 mm, for example in a range from 34.7 to 35.3 mm or in a range from 34.8 to 35.2 mm;
ii) d2 is in a range from 11.7 to 13.2 mm, for example in a range from 11.9 to 12.7 mm or in a range from 12.1 to 12.6 mm;
iii) d3 is in a range from 9.5 to 10.5 mm, for example in a range from 9.6 to 10.4 mm or in a range from 9.7 to 10.3 mm;
iv) d4 is in a range from 5.0 to 7.2 mm, for example in a range from 5.1 to 6.8 mm or in a range from 5.2 to 6.7 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

In some embodiments of the closed container or of the plurality of closed containers provided according to the present invention, the closed container or each closed container in the plurality of closed containers is a vial with an overflow capacity of larger than 4 ml up to maximal 8 ml, for example a vial with a size designation “4R” according to DIN EN ISO 8362-1:2016-06, wherein it is furthermore provided that at least one, for example all, of the following conditions i) to vi) may be fulfilled:
i) h1 is in a range from 44.5 to 45.5 mm, for example in a range from 44.7 to 45.3 mm or in a range from 44.8 to 45.2 mm;
ii) d2 is in a range from 11.7 to 13.2 mm, for example in a range from 11.9 to 12.7 mm or in a range from 12.1 to 12.6 mm;
iii) d3 is in a range from 9.5 to 10.5 mm, for example in a range from 9.6 to 10.4 mm or in a range from 9.7 to 10.3 mm;
iv) d4 is in a range from 5.0 to 7.2 mm, for example in a range from 5.1 to 6.8 mm or in a range from 5.2 to 6.7 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

In some embodiments of the closed container or of the plurality of closed containers provided according to the present invention, the closed container or each closed container in the plurality of closed containers is a vial with an overflow capacity of larger than 8 ml up to maximal 10.75 ml, for example a vial with a size designation “6R” according to DIN EN ISO 8362-1:2016-06, wherein it is furthermore provided that at least one, for example all, of the following conditions i) to vi) may be fulfilled:
i) h1 is in a range from 39.5 to 40.5 mm, for example in a range from 39.7 to 40.3 mm or in a range from 39.8 to 40.2 mm;
ii) d2 is in a range from 17.8 to 20.2 mm, for example in a range from 18.0 to 19.7 mm or in a range from 18.2 to 19.6 mm;
iii) d3 is in a range from 14.0 to 16.5 mm, for example in a range from 14.1 to 16.4 mm or in a range from 14.2 to 16.3 mm;
iv) d4 is in a range from 10.4 to 12.8 mm, for example in a range from 10.5 to 12.4 mm or in a range from 10.6 to 12.3 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

In some embodiments of the closed container or of the plurality of closed containers provided according to the present invention, the closed container or each closed container in the plurality of closed containers is a vial with an overflow capacity of larger than 10.75 ml up to maximal 12.5 ml, for example a vial with a size designation “8R” according to DIN EN ISO 8362-1:2016-06, wherein it is furthermore provided that at least one, for example all, of the following conditions i) to vi) may be fulfilled:
i) h1 is in a range from 44.5 to 45.5 mm, for example in a range from 44.7 to 45.3 mm or in a range from 44.8 to 45.2 mm;
ii) d2 is in a range from 17.8 to 20.2 mm, for example in a range from 18.0 to 19.7 mm or in a range from 18.2 to 19.6 mm;
iii) d3 is in a range from 14.0 to 16.5 mm, for example in a range from 14.1 to 16.4 mm or in a range from 14.2 to 16.3 mm;
iv) d4 is in a range from 10.4 to 12.8 mm, for example in a range from 10.5 to 12.4 mm or in a range from 10.6 to 12.3 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

In some embodiments of the closed container or of the plurality of closed containers provided according to the present invention, the closed container or each closed container in the plurality of closed containers is a vial with an overflow capacity of larger than 12.5 ml up to maximal 16.25 ml, for example a vial with a size designation “10R” according to DIN EN ISO 8362-1:2016-06, wherein it is furthermore provided that at least one, for example all, of the following conditions i) to vi) may be fulfilled:
i) h1 is in a range from 44.5 to 45.5 mm, for example in a range from 44.7 to 45.3 mm or in a range from 44.8 to 45.2 mm;
ii) d2 is in a range from 17.8 to 20.2 mm, for example in a range from 18.0 to 19.7 mm or in a range from 18.2 to 19.6 mm;
iii) d3 is in a range from 14.0 to 16.5 mm, for example in a range from 14.1 to 16.4 mm or in a range from 14.2 to 16.3 mm;
iv) d4 is in a range from 10.4 to 12.8 mm, for example in a range from 10.5 to 12.4 mm or in a range from 10.6 to 12.3 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

According to some embodiments of the closed container or of the plurality of closed containers provided according to the present invention, the closed container or each closed container in the plurality of closed containers is a vial with an overflow capacity of larger than 16.25 ml up to maximal 22.5 ml, for example a vial with a size designation “15R” according to DIN EN ISO 8362-1:2016-06, wherein it is furthermore provided that at least one, for example all, of the following conditions i) to vi) may be fulfilled:
i) h1 is in a range from 59.5 to 60.5 mm, for example in a range from 59.7 to 60.3 mm or in a range from 59.8 to 60.2 mm;
ii) d2 is in a range from 17.8 to 20.2 mm, for example in a range from 18.0 to 19.7 mm or in a range from 18.2 to 19.6 mm;
iii) d3 is in a range from 14.0 to 16.5 mm, for example in a range from 14.1 to 16.4 mm or in a range from 14.2 to 16.3 mm;
iv) d4 is in a range from 10.4 to 12.8 mm, for example in a range from 10.5 to 12.4 mm or in a range from 10.6 to 12.3 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

According to some embodiments of the closed container or of the plurality of closed containers provided according to the present invention, the closed container or each closed container in the plurality of closed containers is a vial with an overflow capacity of larger than 22.5 ml up to maximal 29.25 ml, for example a vial with a size designation “20R” according to DIN EN ISO 8362-1:2016-06, wherein it is furthermore provided that at least one, for example all, of the following conditions i) to vi) may be fulfilled:
i) h1 is in a range from 54.3 to 55.7 mm, for example in a range from 54.5 to 55.5 mm or in a range from 54.6 to 55.4 mm;
ii) d2 is in a range from 17.8 to 20.2 mm, for example in a range from 18.0 to 19.7 mm or in a range from 18.2 to 19.6 mm;
iii) d3 is in a range from 15.0 to 17.5 mm, for example in a range from 15.1 to 17.4 mm or in a range from 15.2 to 17.3 mm;
iv) d4 is in a range from 10.4 to 12.8 mm, for example in a range from 10.5 to 12.4 mm or in a range from 10.6 to 12.3 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

According to some embodiments of the closed container or of the plurality of closed containers provided according to the present invention, the closed container or each closed container in the plurality of closed containers is a vial with an overflow capacity of larger than 29.25 ml up to maximal 35 ml, for example a vial with a size designation “25R” according to DIN EN ISO 8362-1:2016-06, wherein it is furthermore provided that at least one, for example all, of the following conditions i) to vi) may be fulfilled:
i) h1 is in a range from 64.3 to 65.7 mm, for example in a range from 64.5 to 65.5 mm or in a range from 64.6 to 65.4 mm;
ii) d2 is in a range from 17.8 to 20.2 mm, for example in a range from 18.0 to 19.7 mm or in a range from 18.2 to 19.6 mm;
iii) d3 is in a range from 15.0 to 17.5 mm, for example in a range from 15.1 to 17.4 mm or in a range from 15.2 to 17.3 mm;
iv) d4 is in a range from 10.4 to 12.8 mm, for example in a range from 10.5 to 12.4 mm or in a range from 10.6 to 12.3 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

According to some embodiments of the closed container or of the plurality of closed containers provided according to the present invention, the closed container or each closed container in the plurality of closed containers is a vial with an overflow capacity of larger than 35 ml up to maximal 49.75 ml, for example a vial with a size designation “30R” according to DIN EN ISO 8362-1:2016-06, wherein it is furthermore provided that at least one, for example all, of the following conditions i) to vi) may be fulfilled:
i) h1 is in a range from 74.3 to 75.7 mm, for example in a range from 74.5 to 75.5 mm or in a range from 74.6 to 75.4 mm;
ii) d2 is in a range from 17.8 to 20.2 mm, for example in a range from 18.0 to 19.7 mm or in a range from 18.2 to 19.6 mm;
iii) d3 is in a range from 15.0 to 17.5 mm, for example in a range from 15.1 to 17.4 mm or in a range from 15.2 to 17.3 mm;
iv) d4 is in a range from 10.4 to 12.8 mm, for example in a range from 10.5 to 12.4 mm or in a range from 10.6 to 12.3 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

According some embodiments of the closed container or of the plurality of closed containers provided according to the present invention, the closed container or each closed container in the plurality of closed containers is a vial with an overflow capacity of larger than 49.75 ml up to maximal 92.5 ml, for example a vial with a size designation “50R” according to DIN EN ISO 8362-1:2016-06, wherein it is furthermore provided that at least one, for example all, of the following conditions i) to vi) may be fulfilled:
i) h1 is in a range from 72.3 to 73.7 mm, for example in a range from 72.5 to 73.5 mm or in a range from 72.6 to 73.4 mm;
ii) d2 is in a range from 17.8 to 20.2 mm, for example in a range from 18.0 to 19.7 mm or in a range from 18.2 to 19.6 mm;
iii) d3 is in a range from 15.0 to 17.5 mm, for example in a range from 15.1 to 17.4 mm or in a range from 15.2 to 17.3 mm;
iv) d4 is in a range from 10.4 to 12.8 mm, for example in a range from 10.5 to 12.4 mm or in a range from 10.6 to 12.3 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

According to some embodiments of the closed container or of the plurality of closed containers provided according to the present invention, the closed container or each closed container in the plurality of closed containers is a vial with an overflow capacity of larger than 92.5 ml up to maximal 150 ml, for example a vial with a size designation “100R” according to DIN EN ISO 8362-1:2016-06, wherein it is furthermore provided that at least one, for example all, of the following conditions i) to vi) may be fulfilled:
i) h1 is in a range from 99.2 to 100.8 mm, for example in a range from 99.4 to 100.6 mm or in a range from 99.5 to 100.5 mm;
ii) d2 is in a range from 17.8 to 20.2 mm, for example in a range from 18.0 to 19.7 mm or in a range from 18.2 to 19.6 mm;
iii) d3 is in a range from 15.0 to 17.5 mm, for example in a range from 15.1 to 17.4 mm or in a range from 15.2 to 17.3 mm;
iv) d4 is in a range from 10.4 to 12.8 mm, for example in a range from 10.5 to 12.4 mm or in a range from 10.6 to 12.3 mm;
v) r22 is in a range from 0.3 to 1.0 mm, for example in a range from 0.5 to 0.9 mm or in a range from 0.7 to 0.8 mm;
vi) c21 is in a range from 3 to 20°, for example in a range from 5 to 15° or in a range from 7 to 10°.

Measurement Methods

The following measurement methods are to be used in the context of the invention. Unless otherwise specified, the measurements have to be carried out at an ambient temperature of 23° C., an ambient air pressure of 100 kPa (0.986 atm) and a relative atmospheric humidity of 50%.

Determination of h1, h21, h21, r22, r24 and c21

Parameters of h1, h21, h21, r22, r24 and c21 may be determined in at least one cross-sectional view of the vial, wherein the cross-sectional view lies with-in a plane that includes the entire center axis of the vial.

For the determination of lower collar angle c21 the section of the collar's surface is divided into four quarters and the middle two quarters are used for applying the fit in form of the least squares method, for example in the cross-sectional view.

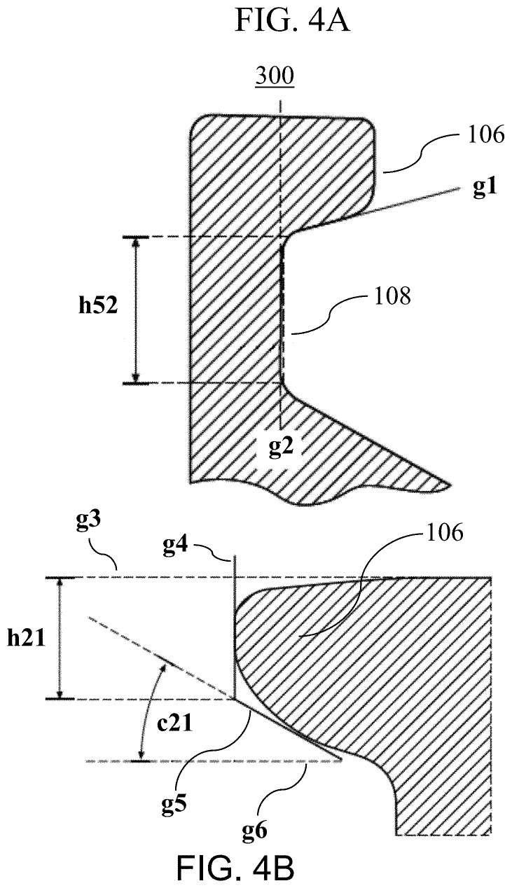

The neck height h21, the collar height h21, the collar and neck radius r22 and the lower collar radius r24 are determined as shown in FIGS. 4A, 4B, 5A, 5B and 6, respectively.

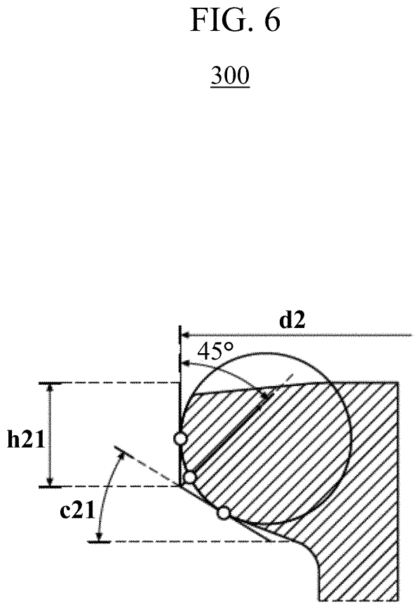

The inner or outer diameters d1, d2, d3 and d4 and the total height h1 of the glass container at a given position are determined in accordance with DIN ISO 8362-1. The outer diameter d2 of the collar region is measured under consideration of the largest radial extend of the collar, as can be exemplarily taken from FIG. 6.

### Example

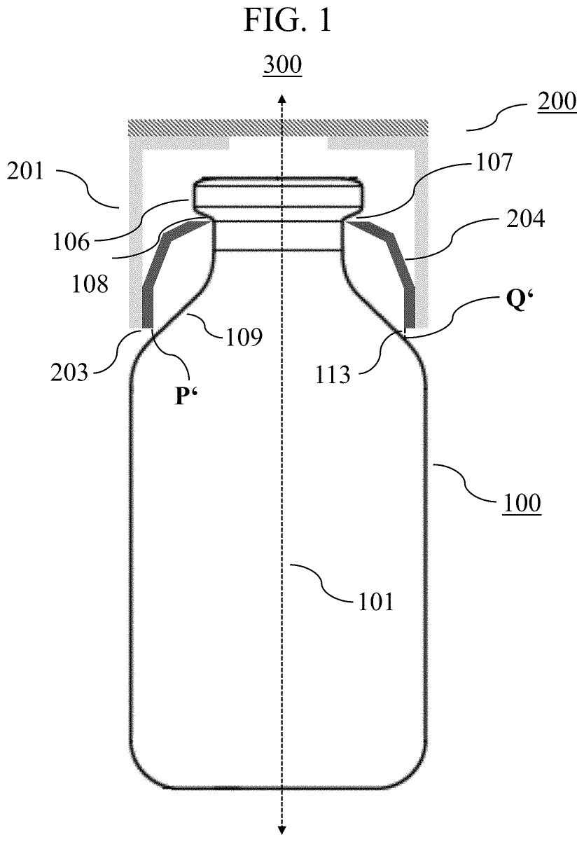

Referring now to the drawings, FIG. 1 shows a closed container 300 provided according to the present invention. The closed container 300 includes a glass container 100 having a center axis 101 and a press-fit-cap 200 by which the glass container 100 is closed, i.e., the press-fit cap 200 closes the glass container 100. The glass container 100 includes, among other parts, a collar region 106, a neck region 108, a transition region 107 that connects the collar region 106 with the neck region 108 and a shoulder region 109. The press-fit cap 200 includes a cylindrical body 201 and one or more engaging clips 204 that are arranged at the inside of the cylindrical body, each clip for example including retaining portions 205 inclined upwardly. The engaging clips 204 are adapted and arranged in such a manner that, when the press-fit cap 200 is pressed over the collar region 106 of the glass container 100 in order to close the glass container 100, the engaging clips 204, for example by the retaining portions 205, engage so as to contact the outside of the glass container 100 in the transition region 107 between the collar region 106 and the neck region 108. In the closed container 300 provided according to the present invention the distance between points P′ and Q′ on the straight line 113 is in a range from 0.17 to 8.4 mm, wherein point P′ is the point at the lower end 203 of the press-fit cap 200 that has the smallest distance to the outer surface of the shoulder region 109.

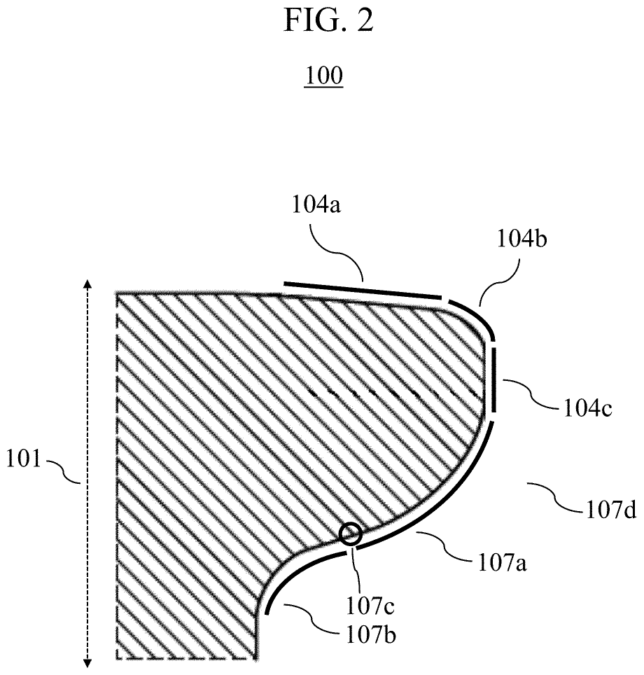

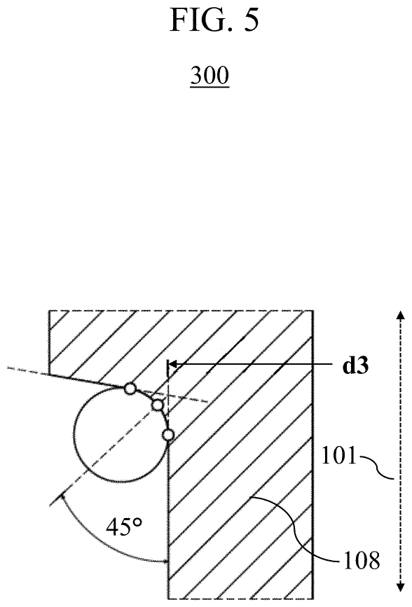

FIG. 2 is a cross-sectional view of the top region 104 and the collar region 106 of a glass container 200 forming a part of the closed container 300 provided according to the present invention. As can be seen, the top region 104 includes a first outer surface 104a inclined downwards towards the collar region 106, a convex curved, circular arc-shaped area 104b adjacent to the first outer surface 104a (see also FIG. 5B) and a second outer surface 104c adjacent to the convex curved, circular arc-shaped area 104b and being substantially parallel to the center axis 101. The outer contour of the transition region 107 that connects the collar region 106 with the neck region 108 includes a convex curved, circular arc-shaped area 107a having a lower collar radius r24 (see also FIG. 6) and a concave curved, circular arc-shaped area 107b having a collar and neck radius r22 (see also FIG. 5A) wherein the outer contour of the transition region 107 further includes a turning point 107c located between the convex curved, circular arc-shaped area 107a and the concave curved, circular arc-shaped area 107b and wherein a tangent line 107d applied at this turning point 107c encloses a lower collar angle c21 (see also FIG. 4B) with an axis perpendicular to the center axis 101.

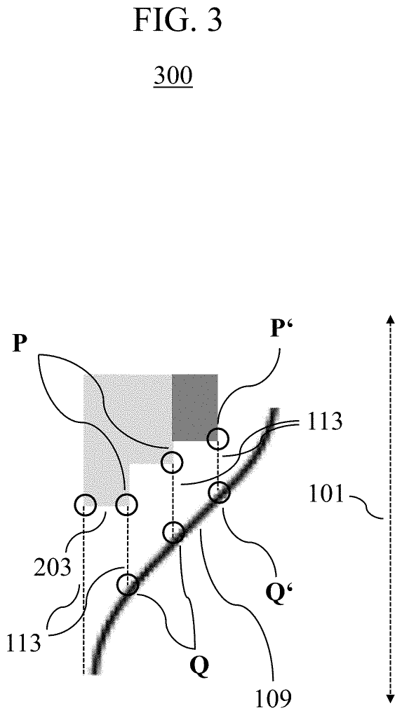

FIG. 3 illustrates how the distance between a given point P at the lower end 203 of the press-fit cap 200 that is located above the shoulder region 109 and that lies on a straight line 113 running parallel to the center axis 101 and hitting the outer surface of the shoulder region 109 at a point Q. Among these points P at the lower end 203 of the press-fit cap 200 point P′ is the one that has the smallest distance to its corresponding point Q′.

FIG. 4A illustrates how to determine the neck height h21. The neck height h21 is the vertical distance between a first and a second point, wherein the first point is the intersection point of the straight line g1 used for determining the lower collar angle and a vertical line g2 which, for example in the cross-sectional view, crosses the most outer circumferential point of the container's neck in the neck region 108, and wherein the second point is the intersection point of the straight line g1 used for determining the shoulder angle and the aforementioned vertical line g2. In some embodiments, the vertical distance is measured along a direction parallel to the center axis 101 of the glass container 100. In some embodiments, the vertical line extends in a direction parallel to the center axis of the vial.

FIG. 4B illustrates how to determine the collar height h21 and the lower collar angle c21. The collar height h21 is the vertical distance between the plane g3 defined by the top of the vial and a specific point, wherein the specific point is obtained as an intersection point of on the one hand a vertical straight line g4 which, for example in the cross-sectional view, touches the most outer circumference point of the container's collar region 106 and on the other hand another straight line g5, wherein another straight line is the straight line used for determining the lower collar angle c21. In some embodiments, the vertical distance is measured along a direction parallel to the center axis of the vial. In some embodiments, the vertical straight line extends in a direction parallel to the center axis of the vial. The lower collar angle c21 is the angle between on the one hand a straight line and on the other hand a plane g6 oriented perpendicular to the center axis of the vial, wherein the straight line is determined, for example in the cross-sectional view, by the least squares method at a section of the surface of the collar region 106 which has a normal vector pointing in a direction towards at least one plane which includes the bottom of the vial. In some embodiments, the section of the surface of the collar region 106 is divided into four quarters and the middle two quarters are used for applying the fit in form of the least squares method, for example in the cross-sectional view.

FIG. 5 illustrates how to determine the collar and neck radius r22. The collar and neck radius r22 is the radius of the circle which has a first straight line and a second straight line as tangents, wherein, for example in the cross-sectional view, the first straight line is parallel to the center axis 101 of the glass container 100 and crosses the outer point of the neck region 108, which may constitute the outer diameter d3 of the neck region 108, wherein, for example in the cross-sectional view, the second straight line is the other straight line used for determining the collar height h21.

FIG. 6 illustrates how to determine the lower collar radius r24. The lower collar radius r24 is the radius of a circle crossing at least three points, wherein, for example in the cross-sectional view, the first point of the at least three ones is the point where a first tangent touches the circle, wherein, for example in the cross-sectional view, the first tangent is the straight line used for determining the lower collar angle c21, wherein, for example in the cross-sectional view, the second point of the at least three ones is the point where a second tangent touches the circle, wherein, for example in the cross-sectional view, the second tangent is parallel to the center axis 101 of the glass container 100 and crosses the outer point of the collar region 106, which may constitute the outer diameter d2 of the collar region 106, wherein, for example in the cross-sectional view, a straight line can be defined which starts at a specific intersection point being the intersection point of the first and second tangent and extends upwards towards the glass container, which straight line encloses an angle of 45° with the second tangent, wherein, for example in the cross-sectional view, the third point is an intersection point of the straight line and the contour of the collar region 106 of the glass container 100, the intersection point being the closest one to the specific intersection point. In other words (see for reference FIG. 6): the lower collar radius r24 is determined using a projected line, the edge of the glass container and two tangent points. A circle is drawn using the tangents and the glass container edge whose radius is the lower collar angle. The projected line is 45° from vertical and starts at the collar height h21 on the line defined in the measurement of the outer diameter d2 of the collar region 106. The edge of the vial seen on this projected line is used, along with the edge defined in the outer diameter d2 of the collar region 106 and the lower collar angle c21 to define the three points, which are used to create the circle. In some embodiments, vertical indicates a direction parallel to the center axis 101 of the glass container.

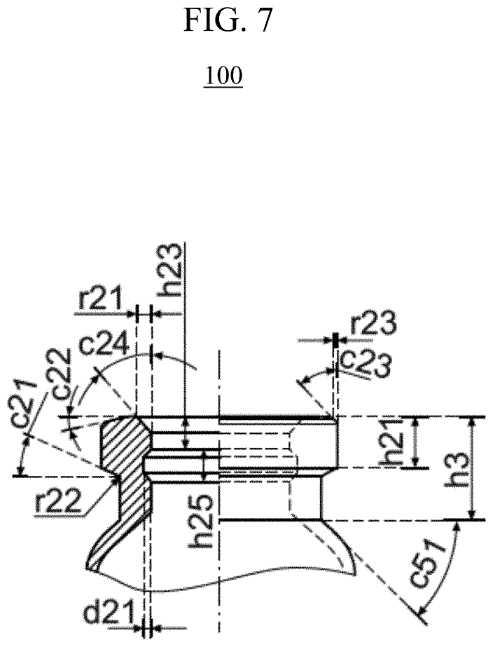

FIG. 7 is a cross-sectional view of the collar region 106, the neck region 108 and the shoulder region 109 of a glass container 100 forming a part of the closed container 300 provided according to the present invention, wherein geometric parameters r22, h21 and c21 are illustrated. Further parameters shown in that figure are, for example, the upper collar angle c22, the collar facet angle c23, the total collar height plus neck height h3 and the shoulder angle c51.

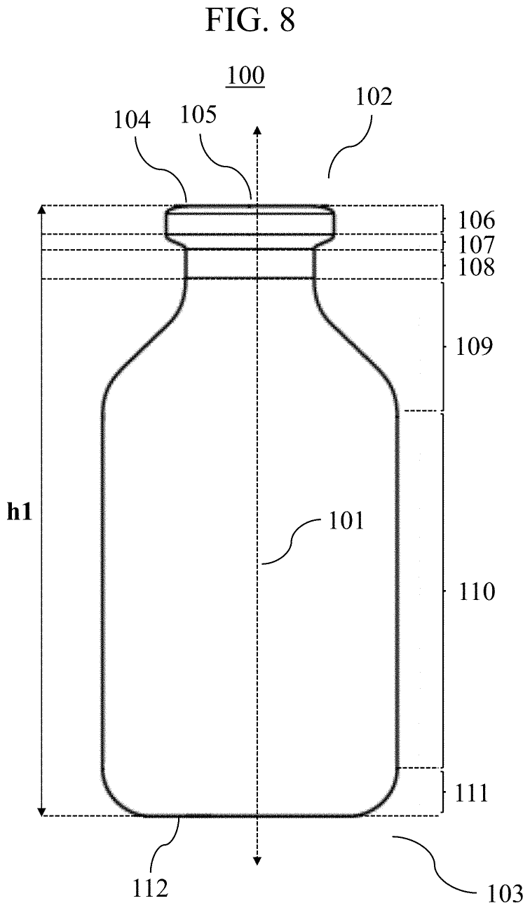

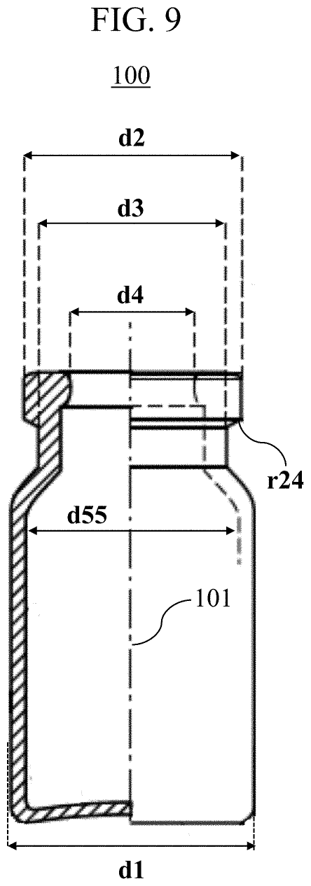

FIGS. 8 and 9 show a glass container 100 that is a part of the closed container 300 provided according to the present invention in a cross-sectional view. Glass container 100 has a total height h1 and a center axis 101. The glass container 100 includes in a direction from the top 102 to the bottom 103 top region 104 that includes an opening 105, a collar region 106 including a collar following the top region 104, wherein the outer diameter of the glass container 100 in the collar region 106 is d2 (see FIG. 9), a transition region 107 that connects the collar region 106 with a neck region 108, the neck region 108 including a neck, wherein the outer diameter of the glass container 100 in the neck region 108 is d3 (see FIG. 9) and wherein the inner diameter of the glass container 100 in the neck region 108 is d4 (see FIG. 9), a shoulder region 109 including a shoulder, a body region 110 including a body that follows the shoulder region 109, wherein the glass container 100 in the body region 110 has an outer diameter d1 (see FIG. 9), a heel region 111 including a heel that follows the body region 110 and a bottom region 112 including a bottom that follows the heel region 111 and that closes the glass container 100 at the bottom 103.

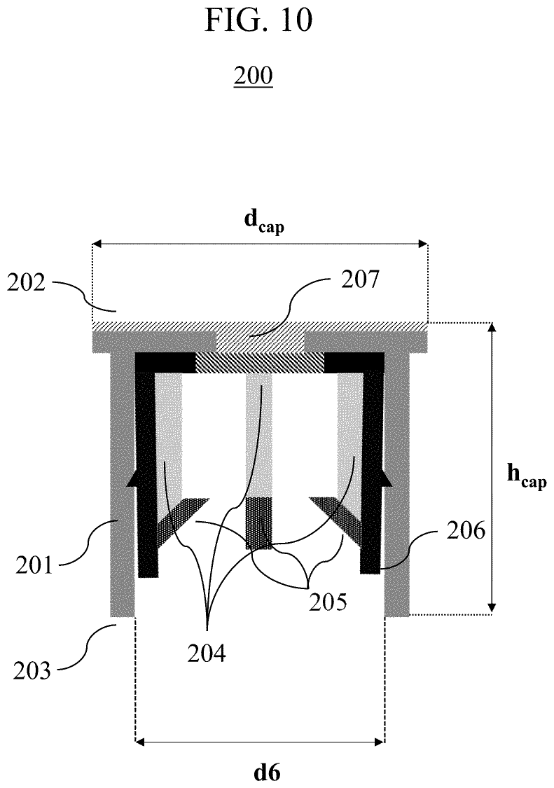

FIG. 10 shows a press-fit cap 200 that is a part of the closed container 300 provided according to the present invention in a cross-sectional view. The press-fit cap 200 includes a cylindrical body 201 having an upper end 202 and a lower end 203 and at least two engaging clips 204 that are arranged at the inside of the cylindrical body 201, each clip 204 for example including retaining portions 205 inclined upwardly, wherein the engaging clips 204 are adapted and arranged in such a manner that, when the press-fit cap 200 is pressed over the collar region 106 of the glass container 100 in order to close the glass container 100, the engaging clips 204, for example by the retaining portions 205, engage so as to contact the outside of the glass container 100 in the transition region 107 between the collar region 106 and the neck region 108. In the embodiment of a press-fit cap 200 as shown in FIG. 10 the cylindrical body 201 has an inner diameter d6 and it may be made of a polymer such as polybutylene terephthalate. In some embodiments, a cage 206 located inside of the cylindrical body 201 includes the at least two engaging clips 204, wherein cage 206 may be made of a polymer such as polycarbonate. As also shown in FIG. 10, the press-fit cap 200 may further include a removable cap 207 that is located on top of the cylindrical body 201, wherein the removable cap 207 may be made of a polymer such as polypropylene. Both, the cylindrical body 201 and the cage 206 at the top of the press-fit cap 200 include an opening which is accessible if the cap 207 is removed.

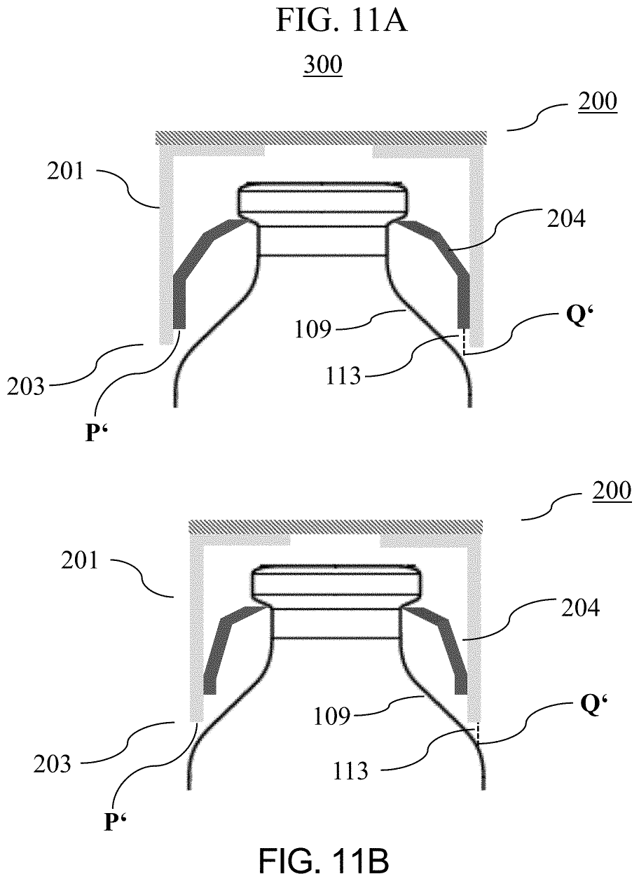

FIGS. 11A and 11B show two different closed containers 300 provided according to the present invention in a cross-sectional view. These containers differ from each other in that different parts of the press-fit cap 200 from the area at the bottom end 203 of the press-fit cap 200 that is closest to the outer surface of the should region 109. In the embodiment shown in FIG. 11A the lower end of the cylindrical body 201 is the part at the lower end 203 of the press-fit cap 200 that is closest to the shoulder region 109 if the glass container 100 is closed with the press-fit cap 200. In the embodiment shown in FIG. 11B the lower end of the cage 206 that is located inside of the cylindrical body 201 is the part at the lower end 203 of the press-fit cap 200 that is closest to the should region 109 if the glass container 100 is closed with the press-fit cap.

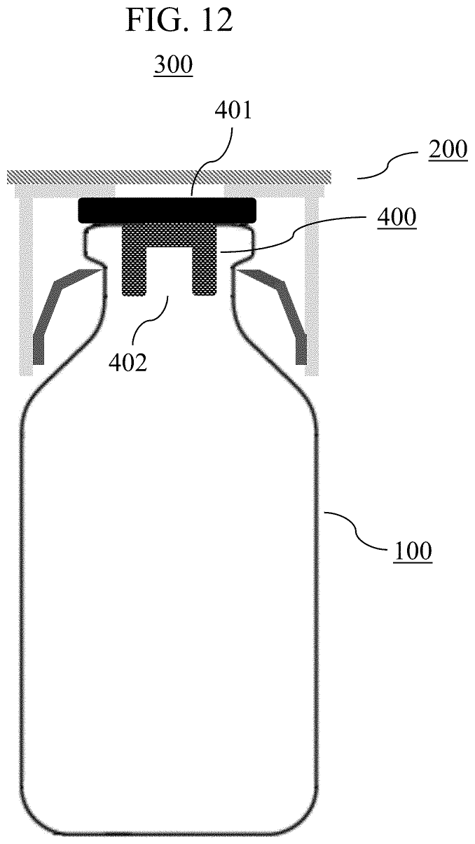

FIG. 12 shows a closed container 300 provided according to the present invention, that in addition to the glass container 100 and the press-fit cap 200 further includes a rubber stopper 400. As shown in FIG. 12, the rubber stopper 400 includes a first portion 401 that rests on the top region 104 of the glass container 100 and a second portion 402 that is inserted into the opening 105 of the top region 104. If such a rubber stopper 400 is used in combination with a press-fit cap 200 as shown in FIG. 10, the first cylindrical portion 401 of the rubber stopper 400 is at least in part accessible if the cap 207 on top of the press-fit cap 200 is removed. Liquids can thus be removed from the glass container 100 by, for example, inserting the needle of a syringe centrally through the rubber stopper 400 into the glass container 100. In the embodiment of a rubber stopper 400 as shown in FIG. 12 the first portion 401 of the rubber stopper 400 has that shape of a disc-shaped flange having a diameter that approximately has the size d2 (i. e. the size of the outer diameter of the glass container 100 in the collar region 106). Attached to the lower side of the first portion 401 of the rubber stopper 400 is the second portion 402 that may be shaped in the form of tubular legs that may be formed to be continuous to a lower surface side of the flange portion 401. Also notches may be provided at two locations in a circumferential direction of such a leg portion. The outer diameter of the second portion 402 may be slightly larger than the inner diameter d4 of the glass container 100 in the neck region 108 in order to ensure that the glass container 100 is sufficiently sealed when the second portion 402 of the rubber stopper 400 is introduced into the opening 105 of the top region 104.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

100 glass container
101 center axis of the glass container 100
102 top of the glass container 100
103 bottom of the glass container 100
104 top region
104a first outer surface of the outer contour of the top region 104
104b convex curved, circular arc-shaped area of the outer contour of the top region 104 adjacent to the first outer surface 104a
104c second outer surface of the outer contour of the top region 104 adjacent to the convex curved, circular arc-shaped area 104b
105 opening
106 collar region
107 transition region that connects the collar region 106 and the neck region 108
107a convex curved, circular arc-shaped area of the outer contour of the transition region 107
107b concave curved, circular arc-shaped area of the outer contour of the transition region 107
107c turning point
107d tangent line
108 neck region
109 shoulder region
110 body region
111 heel region
112 bottom region
113 straight line running parallel to the centra axis 101
200 press-fit cap
201 cylindrical body
202 upper end of cylindrical body 201
203 lower end of cylindrical body 201
204 engaging clips located inside of the cylindrical body 201
205 retaining portions of the engaging clips 204
206 cage located inside of the cylindrical body 201
207 removable cap
300 closed container according to the present invention
400 rubber stopper
401 first portion of the rubber stopper 400
402 second portion of the rubber stopper 400

What is claimed is:

1. At least one closed container, comprising
a glass container, the glass container having a total height (h1) and being characterized by a center axis, the glass container comprising in a direction from a top to a bottom:
a top region that comprises an opening;
a collar region comprising a collar with a collar height (h21) following the top region, wherein an outer diameter of the glass container in the collar region is d2;
a transition region that connects the collar region with a neck region comprising a neck, wherein an outer diameter of the glass container in the neck region is d3 and an inner diameter of the glass container in the neck region is d4;
a shoulder region comprising a shoulder;
a body region comprising a body that follows the shoulder region,
wherein the glass container in the body region has an outer diameter d1;
a heel region comprising a heel that follows the body region; and
a bottom region comprising the bottom that follows the heel region and that closes the glass container at the bottom;
wherein an outer contour of the top region comprises in the following order:
a first outer surface inclined downwards towards the collar region, a convex curved, circular arc-shaped area adjacent to the first outer surface;
a second outer surface adjacent to the convex curved, circular arc-shaped area and being substantially parallel to the center axis;
wherein an outer contour of the transition region that connects the collar region with the neck region comprises in the following order:
a convex curved, circular arc-shaped area having a lower collar radius (r24);
a concave curved, circular arc-shaped area having a collar and neck radius (r22);
wherein the outer contour of the transition region further comprises a turning point located between the convex curved, circular arc-shaped area and the concave curved, circular arc-shaped area and wherein a tangent line applied at this turning point encloses a lower collar angle (c21) with an axis perpendicular to the center axis; and
a press-fit cap closing the glass container, the press-fit cap comprising a cylindrical body having an upper end and a lower end and at least two engaging clips that are arranged at an inside of the cylindrical body, wherein the at least two engaging clips are adapted and arranged in such a manner that, when the press-fit cap is pressed over the collar region of the glass container in order to close the glass container, the engaging clips engage so as to contact an outside of the glass container in the transition region between the collar region and the neck region;
wherein P is any given point at a lower end of the press-fit cap that is located above the shoulder region and that lies on a straight line running parallel to the center axis and hitting an outer surface of the shoulder region at a point Q, wherein among these points P at the lower end of the press-fit cap a point P′ is the one that has the smallest distance to its corresponding point Q′, wherein a distance between points P′ and Q′ on the straight line is in a range from 0.17 to 8.4 mm.

2. The at least one closed container of claim 1, wherein d2 is in a range from 11.7 to 13.2 mm.

3. The at least one closed container of claim 1, wherein d2 is in a range from 17.8 to 20.2 mm

4. The at least one closed container of claim 1, wherein d3 is in a range from 9.5 to 10.5 mm.

5. The at least one closed container of claim 1, wherein d3 is in a range from 14.0 to 16.5 mm.

6. The at least one closed container of claim 1, wherein d3 is in a range from 15.0 to 17.5 mm.

7. The at least one closed container of claim 1, wherein d4 is in a range from 5.0 to 7.2 mm.

8. The at least one closed container of claim 1, wherein d4 is in a range from 10.4 to 12.8 mm.

9. The at least one closed container of claim 1, wherein r22 is in a range from 0.3 to 1.0 mm.

10. The at least one closed container of claim 1, wherein r24 is 0.5 mm or less.

11. The at least one closed container of claim 1, wherein c21 is in a range from 3 to 20°.

12. The at least one closed container of claim 1, wherein the outer contour of the top region further comprises a third outer surface adjacent to the first outer surface, wherein the third outer surface is inclined downwards into the inside of the glass container and which encloses an angle (c24) with the center axis, wherein c24 is in a range from 30 to 50°.

13. The at least one closed container of claim 1, wherein the neck height h21 is in a range from 1.3 to 3.6 mm.

14. The at least one closed container of claim 1, wherein the press-fit cap has a maximum outer diameter d_{cap} in a range from 13.4 to 14.4 mm.

15. The at least one closed container of claim 1, wherein the press-fit cap has a maximum outer diameter d_{cap} in a range from 20.1 to 21.5 mm.

16. The at least one closed container of claim 1, wherein the press-fit cap has a height h_{cap} in a range from 4.5 to 7.5 mm.

17. The at least one closed container of claim 1, further comprising a rubber stopper comprising a first portion that rests on the top region and a second portion that is inserted into the opening of the top region.

18. The at least one closed container of claim 1, further comprising a vial adaptor.

19. The at least one closed container of claim 18, wherein the vial adaptor has an inner diameter and a height with such dimensions that the vial adaptor can be placed on the press-fit cap.

20. The at least one closed container of claim 1, further comprising a liquid composition or a solid composition.
